(19) United States
(12) Patent Application Publication
(10) Pub. No.: US 2016/0083593 A1
(43) Pub. Date: Mar. 24, 2016

(54) Intumescent composition and the use thereof

(71) Applicant: Hilti Aktiengesellschaft, Schaan (LI)

(72) Inventors: Juliane Marauska, Reutlingen (DE); Johannes Brinkhorst, Landsberg (DE); Mario Paetow, Igling (DE); Ingrid Wolfle, Augsburg (DE); Wolfgang Lewandowski, Augsburg (DE); Sebastian Simon, Buchloe Lindenberg (DE)

(21) Appl. No.: 14/959,725

(22) Filed: Dec. 4, 2015

Related U.S. Application Data
(63) Continuation of application No. PCT/EP2014/061782, filed on Jun. 6, 2014.

(30) Foreign Application Priority Data
Jun. 6, 2013 (EP) 13170748.1

(51) Int. Cl. C09D 5/18; C09D 175/02

(52) U.S. Cl. CPC C09D 5/185; C09D 175/02

(57) ABSTRACT

An intumescent composition is described which contains a binder based on polyurea. Using the composition, which has a relatively high rate of expansion, it is possible to easily and quickly apply coatings at the layer thickness required for the specific fire resistance duration, wherein the layer thickness can be reduced to a minimum yet still reach a high insulating value. The composition is particularly suitable for fire protection, particularly as a coating for metallic and non-metallic substrates such as steel components including columns, beams, or truss rods for the purpose of increasing fire resistance time.

### RELATED APPLICATIONS

This application claims priority to, and is a continuation of, co-pending PCT Application No. PCT/EP2014/061782 having an International filing date of Jun. 6, 2014, which is incorporated herein by reference, and which claims priority to European Patent Application No. EP 13170748.1, having a filing date of Jun. 6, 2013, which is also incorporated herein by reference] in its entirety.

### SUMMARY OF THE TECHNOLOGY

The present technology relates to an intumescent composition, particularly a composition having intumescent properties, which contains a binder based on polyurea, and to the use thereof for fire protection, particularly for coatings of components, such as columns, beams, or truss rods for the purpose of increasing fire resistance.

### BACKGROUND

Intumescent compositions, which form an insulation layer, are usually applied to the surface of components for the purpose of forming coatings in order to protect them from fire or intense heat exposure as a result of a fire. Steel structures are now an integral part of modern architecture, even if they have a crucial disadvantage compared to reinforced concrete. Above about 500° C., the load carrying capacity of the steel is reduced by 50%—that is, the steel loses much of its stability and its viability. This temperature can be reached, depending on fire load, such as direct fire exposure (approximately 1000° C.), after only about 5-10 minutes, which often leads to a loss of carrying capacity of the construction. The objective of fire protection, in particular steel fire protection, is to delay the duration of time for viability loss of a steel structure in case of fire, for the purpose of saving human lives and valuable goods as long as possible.

The building regulations of many countries require appropriate fire resistance times for certain structures of steel. They are defined by so-called F-classes such as F 30, F 60, F 90 (fire resistance classes according to DIN 4102-2), or American ASTM classes, etc. This means, in accordance with DIN 4102-2 F 30, for example, that a load-bearing steel structure can withstand a fire for at least 30 minutes under normal conditions. This is usually achieved by retarding the heating rate of the steel—for example by coating the steel structure with intumescent coatings. These are paints with components which form a solid microporous carbon foam in case of fire. In this case, a fine-pored and thick foam layer, the so-called ash crust, is formed, which is highly thermally insulating depending on the composition, and therefore delays the heating of the component such that the critical temperature of about 500° C. is reached at the earliest after 30, 60, 90, 120, or up to 240 minutes. The thickness of the coating applied and/or the ash crust which develops therefrom is always essential for the attainable fire resistance. Closed profiles, such as tubes, require about twice the amount for a comparable mass compared to open sections, such as beams with a double-T profile. For compliance with the required fire resistance times, the coatings must have a certain thickness and have the ability to form the most voluminous, and therefore well-insulating, ash crust possible when exposed to heat, with the ash crust remaining mechanically stable over the period of fire exposure.

There are different systems in the prior art for this purpose. There are basically 100% systems and solvent- or water-based systems. In the solvent or water-based systems, binders, which are usually resins, are applied as a solution, dispersion or emulsion to the component. These can be designed as single or multi-component systems. After application, the solvent and/or water evaporates and leaves behind a film that dries with time. In this category, a further distinction can be made between systems in which the coating does not substantially change during the drying, and systems in which the binder is primarily cured following evaporation by oxidation and polymerization reactions, induced for example by atmospheric oxygen. The 100% systems contain the components of the binder without solvents or water. They are applied to the component, and the “drying” of the coating takes place only by the reaction of the binder constituents with each other.

The systems based on solvent or water have the disadvantage that the drying times—also called curing times—are long, and also more layers have to be applied, which require several operations, in order to achieve the required layer thickness. Since each layer must be dried appropriately before the application of the next layer, this results in a high expenditure of labor and accordingly high costs, as well as a delay in the completion of the building. Depending on climatic conditions, in some cases several days can pass before the required thickness is applied. Another disadvantage is that the coating can tend to cracking and flaking during drying or exposure to heat, as a result of the required layer thickness, and in the worst case, the surface can be partially exposed, particularly in systems where the binder does not post-cure after the solvent and the water have evaporated.

To overcome this disadvantage, two- or multi-component systems based on epoxy-amines have been developed that work with almost no solvent, such that curing is much faster and also thicker layers can be applied in one step, such that the required layer thickness is built up much faster. However, these have the disadvantage that the binder is a very stable and rigid polymer skeleton, frequently softening in a high temperature range, which hinders the formation of foam by the foaming agent. Therefore, thick films must be applied in order to generate a sufficient foam thickness for insulation. This is in turn disadvantageous because a great deal of material is required. To make these systems applicable, processing temperatures of up to +70° C. are often required, which makes the use of these systems laborious and expensive to install.

### BRIEF SUMMARY

An intumescent composition, comprises (1) an A component containing an isocyanate compound, (2) a B component containing a reactive component which is capable of reacting with isocyanate compounds and which is selected from among compounds with at least two amino groups, wherein the amino groups are primary and/or secondary amino groups irrespective of each other, and (3) a C component containing an intumescent additive, wherein the intumescent additive is a mixture, optionally containing at least one carbon source, at least one dehydrogenation catalyst, and at least one blowing agent.

The reactive component which is capable of reacting with isocyanate compounds can be selected from among polyamines, polyether polyamines, and polyaspartic esters, or a mixture thereof. For example, it can be a polyether polyamine selected from among compounds having the general formula (I)

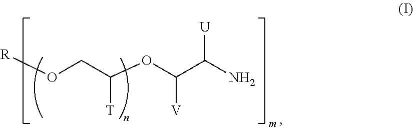

in which
R is the moiety of an initiator for oxyalkylation, having 2 to 12 carbon atoms and 2 to 8 groups containing active hydrogen atoms,
T is hydrogen or a C₁C₄-alkyl group,
V and U are hydrogen or T, irrespective of each other,
n is a value between 0 and 100 is,
m is a whole number between 2 and 8, wherein m corresponds to the number of groups with an active hydrogen atom which were originally contained in the initiator for the oxyalkylation. In another example, it can be a polyaspartic ester having the general formula (VII),

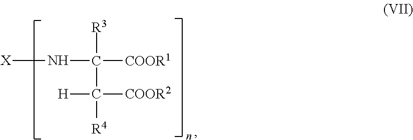

in which
R¹ and R² can be the same or different, and represent organic moieties which are inert towards isocyanate groups,
R³ and R⁴ can be the same or different and represent hydrogen or organic moieties which are inert to isocyanate groups,
X is an n-valent organic moiety which is inert towards isocyanate groups, and
n is a whole number of at least 2. Alternatively, in formula (VII), R¹ and R² are a methyl- or ethyl-group irrespective of each other, and R³ and R⁴ each represent hydrogen. In another embodiment, in Formula (VII), X represents a moiety as can be obtained by the removal of the primary amino group from an aliphatic polyamine. In yet another embodiment, X represents a moiety as can be obtained by the removal of the primary amino-groups from 1,4-diaminobutane, 1,6-diaminohexane, 2,2,4- or 2,4,4-trimethyl-1,6-diaminohexane, 1-amino-3,3,5-trimethyl-5-aminomethylcyclohexane, 4,4′-diaminodicyclohexylmethane, or 3,3′-dimethyl-4,4′-diamino-dicyclohexylmethane, diethylene triamine and triethylene tetramine, wherein n represents the number 2.

In another embodiment, the B component can furthermore contain a polyol compound. The polyol compound can be selected from among polyester polyols, polyether polyols, hydroxylated polyurethanes and/or alkanes, each having two hydroxyl-groups per molecule. In another example, the polyol compound is selected from among compounds which have a backbone of polyester, polyether, polyurethane, and/or alkanes or mixtures of these and one or more hydroxyl-groups.

In yet another embodiment, the isocyanate compound has an aliphatic or aromatic backbone and at least two isocyanate groups or a mixture thereof.

In one embodiment, the A and B components can be selected such that the ratio of equivalents of isocyanate groups of the isocyanate compound to the groups, the same being capable of reaction with the isocyanate group, of the reactive component which is capable of reaction with isocyanate compounds, is between 0.3 and 1.7.

The composition can furthermore contain a catalyst for the reaction between the isocyanate compound and the reactive component which is capable of reacting with isocyanate compounds and/or the polyol.

The intumescent additive can furthermore include at least one compound capable of thermal expansion. The intumescent additive can also furthermore contain an ash crust stabilizer.

The composition can furthermore contain organic and/or inorganic additives, and/or additional additives.

The composition can be produced as a two- or multi-component system. For example, the composition can be produced as a two-component system, and the A component and the B component are separated into two components, component I and component II, to prevent reaction. In this example, the C component, which optionally contains at least one carbon source, at least one blowing agent, and at least one dehydrogenation catalyst, cab be divided among component I and component II in such a manner that these compounds are separated from each other to prevent reaction. In this example, the C component can furthermore contain an ash crust stabilizer which is divided among component I and component II in such a manner that component I or component II contains at least a portion of the ash crust stabilizer, and component II or component I optionally contains a further portion of the ash crust stabilizer.

The composition can be used as a coating. For example, it can be a coating of steel construction elements, of metallic and/or non-metallic substrates. It can also be used as a fire protection layer.

Cured objects can also be obtained by curing the composition.

### BRIEF DESCRIPTION OF SEVERAL VIEWS OF THE DRAWINGS

[Not Applicable]

### DETAILED DESCRIPTION

The problem addressed by the invention is therefore that of providing an intumescent composition for coating systems of the aforementioned type, which avoids the disadvantages mentioned, which is particularly not based on solvent or water and which cures quickly, which is easy to apply due to accordingly adapted viscosity, and which, because of the favorable intumescence rate which can be achieved—that is, the formation of an effective ash crust layer—only requires a low layer thickness.

This problem is addressed by the composition according to claim 1. Preferred embodiments are disclosed in the dependent claims.

The object of the invention is therefore an intumescent composition, having an A component containing an isocyanate compound, having a B component, which contains a reactive component which is capable of reacting with isocyanate compounds and which is selected from among compounds with at least two amino groups, wherein the amino groups are primary and/or secondary amino groups irrespective of each other, and having a C component containing an intumescent additive, wherein the intumescent additive is a mixture, optionally containing at least one carbon source, at least one dehydrogenation catalyst, and at least one blowing agent.

Using the composition according to the invention, it is possible to apply coatings with the layer thickness required for the specific fire resistance time in a simple and rapid manner. The advantages achieved by the invention are essentially that it is possible to significantly shorten inherently slow curing times of the systems based on solvent or water, which greatly reduces the labor time. Due to the low viscosity of the composition in the application area, as adjusted by suitable thickener systems, it is possible, in contrast to epoxy-amine systems, to make the application without heating the composition, using the widespread airless spraying method, by way of example.

Due to the lower softening temperature of the polymer skeleton, compared to the systems based on epoxy-amine, the intumescence is relatively high with respect to the rate of expansion, such that even with thin layers a great insulating effect is achieved. The possible high degree of filling of the composition with fire retardant additives, which can be achieved, inter alia, by the fact that the composition can be formulated as a two- or multi-component system, also makes a contribution to the above trait. Accordingly, the cost of materials drops, which is a particularly favorable effect on the cost of materials in large-scale applications. This is achieved in particular through the use of a reactive system that cures by poly-addition, rather than physically drying, and therefore does not experience any volume loss as a result of the drying of solvents—or in water-based systems, of water. In a conventional system, a solvent content of about 25% is typical. In the composition according to the invention, more than 95% of the coating remains on the substrate being protected. Furthermore, the relative stability of the ash crust is very high due to the advantageous structure of the foam formed in a fire.

Compared with solvent or water based systems, when applied without primer, compositions according to the invention demonstrate excellent adhesion to various metallic and non-metallic substrates, as well as excellent cohesion and impact resistance.

The following explanations of terminology used below are provided for greater understanding of the invention. In the context of the invention:
the term “aliphatic compound” includes acyclic and cyclic, saturated or unsaturated hydrocarbon compounds which are not aromatic (PAC, 1995, 67, 1307; Glossary of Class Names of Organic Compounds and reactivity intermediates based on structure (IUPAC Recommendations 1995));
the term “polyamine” means a saturated, open-chain or cyclic organic compound which is interposed by a varying number of secondary amino groups (—NH—) and, in particular in the case of open-chain compounds, by primary amino groups (—NH₂) at the chain ends;
“organic moiety” means a hydrocarbon moiety which can be saturated or unsaturated, substituted or unsubstituted, aliphatic, aromatic or araliphatic; wherein “araliphatic” means that both aromatic and aliphatic moieties are included;
“chemical intumescence” means the formation of a voluminous, insulating layer of ash from mutually adapted compounds which react with one another when exposed to heat;
“physical intumescence” means the formation of a voluminous insulating layer by the swelling of a compound which releases gases when exposed to heat, without a chemical reaction having taken place between the two compounds, whereby the volume of the compound increases by a multiple of the original volume;
“intumescent” means that a solid, microporous carbon foam is created in a fire, such that the resulting fine pores and thick foam layer, the so-called ash crust, insulate a substrate against heat according to the composition;
“carbon source” means an organic compound which leaves a carbon skeleton as a result of incomplete combustion, and does not completely combust to form carbon dioxide and water (carbonization); these compounds are referred to as “carbon skeleton builders”;
an “acid generator” is a compound that when exposed to heat—that is, above about 150° C., forms a non-volatile acid, for example by decomposition, and therefore acts as a catalyst for the carbonization; it can also contribute to lowering the viscosity of the melt of the binder; hereby equivalent to the term “dehydrogenation catalyst”;
a “blowing agent” is a compound which decomposes at elevated temperature and evolves inert—that is, non-combustible—gases, and which expands the carbon skeleton formed by the carbonization, and optionally the softened binder, to create a foam (intumescence); this term is used interchangeably with “gas formers”;
an “ash crust stabilize?” is a so-called skeleton-forming compound which stabilizes the carbon skeleton (ash crust) formed by the interaction of the carbon formation from the carbon source and the gas from the blowing agent or the physical intumescence. The mode of action in principle is that carbon layers formed, which are by themselves very soft, are mechanically reinforced by inorganic compounds; the addition of such an ash crust stabilizer contributes to a significant stabilization of the intumescence crust in a fire, as these additives increase the mechanical strength of the intumescent layer and/or prevent their loss by dripping, thereby maintaining or enhancing the insulating effect of the foam.

All aliphatic and/or aromatic isocyanates known to a person skilled in the art, having an average NCO functionality of 1 or greater, preferably greater than 2, can be used individually or in any desired mixtures with one another as the isocyanate compound.

Examples of aromatic polyisocyanates are 1,4-phenylene diisocyanate, 2,4- and/or 2,6-toluylene diisocyanate, xylene diisocyanate, hydrogenated xylene diisocyanate, tetramethylxylylene diisocyanate, 1,5-naphthylene diisocyanate, diphenylene-2,4′- and/or -4,4′-diisocyanate, triphenylmethane-4,4′,4″-triisocyanate and bis- and tris-(isocyanatoalkyl)benzenes, toluenes, and xylols.

Preference is given to isocyanates from the series of aliphatic representatives having a carbon backbone (without the included NCO groups) of 3 to 30, and preferably 4 to 20, carbon atoms. Examples of aliphatic polyisocyanates are bis-(isocyanatoalkyl) ethers or alkane diisocyanates such as propane diisocyanates, butane diisocyanates, pentane diisocyanates, hexane diisocyanates (for example hexamethylene diisocyanate, HDI), heptane diisocyanates, octane diisocyanates, nonane diisocyanates (for example, trimethyl-HDI (TMDI) typically as a mixture of 2,4,4- and 2,2,4-isomers), 2-methylpentane-1,5-diisocyanate (MPDI), nonane triisocyanates (for example, 4-isocyanatomethyl-1,8-octane diisocyanate), decane diisocyanates, decane triisocyanates, undecane diisocyanates, undecane triisocyanates, dodecane diisocyanates, dodecane triisocyanates, 1,3- and 1,4-bis(isocyanatomethyl)cyclohexane (H₆XDI), 3-isocyanatomethyl-3,5,5-trimethylcycloheylisocyanate (isophorone diisocyanate, IPDI), bis-(4-isocyanatocyclohexyl)methane (H₁₂MDI), bis-(isocyanatomethyl)norbornane (NBDI) or 3(4)-isocyanatomethyl-1-methylcyclohexyl isocyanate (IMCI).

Particularly preferred isocyanates are hexamethylene diisocyanate (HDI), trimethyl-HDI (TMDI), 2-methyl pentane-1,5-diisocyanate (MPDI), isophorone diisocyanate (IPDI), 1,3- and 1,4-bis-(isocyanatomethyl)cyclohexane (H₆XDI), bis-(isocyanatomethyl)norbornane (NBDI), 3(4)-isocyanatomethyl-1-methylcyclohexyl isocyanate (IMCI) and/or 4,4′-bis-(iso-cyanatocyclohexyl)methane (H₁₂MDI), or mixtures of these isocyanates.

More preferably, the polyisocyanates are present as prepolymers, biurets, isocyanurates, iminooxadiazinediones, uretdiones and/or allophanates, prepared by reaction with polyols or polyamines, individually or as a mixture, and have an average functionality of 1 or greater, and preferably 2 or greater.

Examples of suitable commercially available isocyanates are Desmodur® N 3900, Desmodur® N 100, Desmodur® N 3200, Desmodur® N 3300, Desmodur® N 3600, Desmodur® N 3800, Desmodur®XP 2675, Desmodur® 2714 Desmodur® 2731, Desmodur® N 3400, Desmodur® XP 2580, Desmodur® XP 2679, Desmodur® XP 2731, Desmodur® XP 2489, Desmodur® E 305, Desmodur® E 3370, Desmodur® XP 2599, Desmodur® XP 2617, Desmodur® XP 2406 Desmodur® VL, Desmodur® VL 50, Desmodur® VL 51 (each from Bayer MaterialScience AG), Tolonate HDB, Tolonate HDT (Rhodia), Basonat HB 100 and Basonat HI 100 (BASF).

The amines which can be used, and which are able to react with isocyanate compounds, include all compounds having at least two amino groups, wherein the amino groups are primary and/or secondary amino groups which are capable of reacting with isocyanate groups to form a urea group (—N—C(O)—N—), said compounds being known to a person skilled in the art.

In one embodiment of the invention, the reactive compound which is capable of reacting with isocyanate compounds is a polyamine, such as 1,2-diaminocyclohexane, 4,4′-diaminodiphenyl sulfone, 1,5-diamino-2-methylpentane, diethylenetriamine, hexamethylene diamine, isophorone diamine, triethylenetetramine, trimethylhexamethylenediamine, and 5-amino-1,3,3-trimethylcyclohexane-1-methylamine.

These polyamines are highly reactive with isocyanate groups, such that the reaction between the amino group and the isocyanate group occurs within a few seconds.

For this reason, compounds which react less quickly with the isocyanate groups, such as the so-called polyether polyamines, are preferred. The polyether polyamines, also called alkoxylated polyamines or polyoxyalkene polyamines, include compounds containing aliphatically bound amino groups—that is, the amino groups are attached to the ends of a polyether backbone. The polyether backbone is based on pure or mixed polyalkylene oxide units such as polyethylene glycol (PEG) or polypropylene glycol (PPG). The polyether skeleton is obtained by reacting a di- or tri-alcohol initiator with ethylene oxide (EO) and/or propylene oxide (PO), with subsequent conversion of the terminal hydroxyl groups to amino groups.

Suitable polyether polyamines are represented by the following general formula (I)

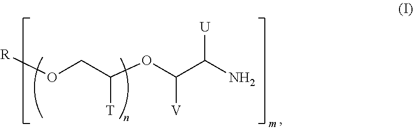

in which
R is the moiety of an initiator for the oxyalkylation, having 2 to 12 carbon atoms and 2 to 8 groups containing active hydrogen atoms,
T is hydrogen or a C₁C₄-alkyl group,
V and U are hydrogen or T, irrespective of each other,
n is a value between 0 and 100 is,
m is an integer between 2 and 8, wherein m corresponds to the number of groups with an active hydrogen atom which were originally contained in the initiator for the oxyalkylation.

In further embodiments, n has a value between 35 and 100, or less than 90, less than 80, less than 70 or less than 60. In another embodiment, R has from 2 to 6 or 2 to 4 or 3 groups with active hydrogen atoms, in particular hydroxyl-groups. In another embodiment, R is an aliphatic initiator with multiple active hydrogen atoms. In another embodiment, T, U and V are each methyl groups.

In this context, reference is hereby made to the U.S. Pat. No. 4,940,770 and the patent applications DE 26 09 488 A1 and WO 2012/030338 A1, the contents of which are hereby incorporated into this application.

Examples of suitable polyetheramines are the polyetheramines sold by Huntsman Corporation under the trademark JEFFAMINE® in the D, ED, EDR, and T series, wherein the D series includes diamines and the T series includes triamines, the E series includes compounds having a backbone consisting substantially of polyethylene glycol, and the R-series includes highly reactive amines.

The products of the D-series include amino-terminated polypropylene glycols of the general formula (II),

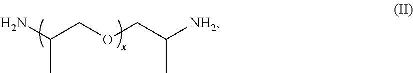

in which x is a number having an average value between 2 and 70. Commercially available products of this series are JEFFAMINE® D-230 (n˜2.5/Mw 230), JEFFAMINE® D-400 (n˜6.1/Mw=430), JEFFAMINE® D-2000 (n˜33/Mw 2000) and JEFFAMINE® D-4000 (n˜68/MW 4000).

The products in the ED-Series include amino-terminated polyethers based on a substantially polyethylene glycol skeleton having the general formula (III),

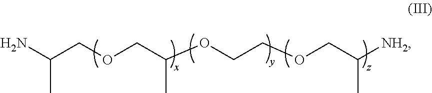

in which y is a number having an average value between 2 and 40 and x+z is a number having an average value from 1 to 6. Commercially available products in this series are: JEFFAMINE® HK511 (y=2.0; x+z˜1.2/Mw 220), JEFFAMINE® ED-600 (y˜9.0; x+z˜3.6/Mw 600), JEFFAMINE® ED-900 (y˜12.5; x+z˜6.0/Mw 900) and JEFFAMINE® ED-2003 (y˜39; x+z˜6.0/Mw 2000).

The products in the EDR series include amino terminated polyethers with the general formula (IV)

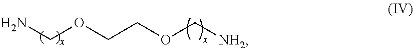

in which x is an integer from 1 to 3. Commercially available products in this series are: JEFFAMINE® DER-148 (x=2/Mw 148) and JEFFAMINE® DER-176 (x=3/Mw 176).

The products of the T-Series include triamines which are obtained by the reaction of propylene oxide with a triol initiator, followed by amination of the terminal hydroxyl groups, having the general formula (V) or being isomers thereof:

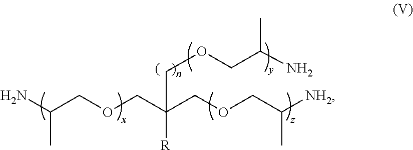

in which R is hydrogen or a C₁C₄-alkyl group, preferably hydrogen or ethyl-, n is 0 or 1 and x+y+z corresponds to the number of moles of propylene oxide units, wherein x+y+z is a whole number between about 4 and about 100, particularly between about 5 and about 85. Commercially available products of this series are: JEFFAMINE® T-403 (R═C₂H₅; n=1; x+y+z=5-6/Mw 440), JEFFAMINE® T-3000 (R═H; n=0; x+y+z=50/Mw 3000), and JEFFAMINE® T-5000 (R═H; n=0; x+y+z=85/Mw 5000).

Also suitable are the secondary amines of the SD and ST series, wherein the SD series comprises secondary diamines and the ST series comprises secondary triamines, which are obtained from the above series by reductive alkylation of the amino groups, by reacting the amino end groups with a ketone such as acetone and then reducing the same, such that the sterically hindered secondary amino end groups of the general formula (VI) are obtained:

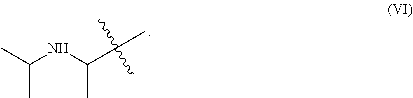

Commercially available products of this series are: JEFFAMINE® SD-231 (starting material D230/Mw 315), JEFFAMINE® SD-401 (starting material D-400/Mw 515), JEFFAMINE® SD-2001 (starting material D-2000/Mw 2050) and JEFFAMINE ST-404 (starting material T-403/Mw 565).

In one particularly preferred embodiment of the invention, polyaspartic esters, the so-called polyaspartics, are used as the reactive components which are capable of reacting with isocyanate compounds, since their reactivity towards isocyanate groups compared with the other polyamines described above is significantly reduced. This leads to the advantage that the processing time of a composition with an isocyanate component and a polyaspartic ester component is extended, which leads to an improved handling by the user.

Suitable polyaspartic esters are chosen from compounds having the general formula (VII),

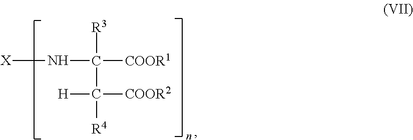

in which R¹ and R² can be the same or different, and represent organic moieties which are inert towards isocyanate groups, R³ and R⁴ can be the same or different and represent hydrogen or organic moieties which are inert to isocyanate groups, X is an n-valent organic moiety which is inert towards isocyanate groups, and n is an integer of at least 2, preferably from 2 to 6, more preferably from 2 to 4 and most preferably is 2. R¹ and R² are preferably an optionally substituted hydrocarbon group, irrespective of each other, preferably a C₁-C₉ hydrocarbon group, and more preferably a methyl-, ethyl- or butyl-group, and R³ and R⁴ preferably each represent hydrogen.

In one embodiment, X is an n-valent hydrocarbon group obtained by removing the amino groups from an aliphatic or araliphatic polyamine, preferably by removing the primary amino groups from an aliphatic polyamine, and more preferably a diamine. The term ‘polyamine’ in this context includes compounds having two or more primary and optionally additional secondary amino groups, wherein the primary amino groups are preferably terminal.

In one preferred embodiment, X is a moiety which can be obtained by the removal of the primary amino groups of 1,4-diaminobutane, 1,6-diaminohexane, 2,2,4- or 2,4,4-trimethyl-1,6-diaminohexane, 1-amino-3,3,5-trimethyl-5-aminomethylcyclohexane, 4,4′-diaminodicyclohexylmethane, or 3,3′-dimethyl-4,4′-diamino-dicyclohexylmethane, diethylene triamine and triethylene tetramine, wherein n in formula (VII) represents the number 2.

In this context, reference is hereby made to the applications EP 0403921 A2 and EP 0743332 A1, the contents of which are hereby incorporated into this application.

Mixtures of polyaspartic esters can also be used.

Examples of suitable polyaspartic esters are sold by Bayer MaterialScience AG under the brand DESMOPHEN®. Commercially available products are for example: DESMOPHEN® NH 1220, DESMOPHEN® NH 1420 and DESMOPHEN® NH 1520.

The described reactive components which are capable of reacting with isocyanate compounds can be used individually or as a mixture depending on the desired reactivity. In this case the polyamines can particularly serve as bridging compounds when used in addition to the polyaspartic acid esters or polyether polyamines.

The proportion of the A and B components is preferably selected such that the ratio of equivalents of isocyanate groups of the isocyanate compound to the groups, the same being capable of reaction with the isocyanate group, of the reactive compounds which are capable of reaction with isocyanate compounds, is between 0.3 and 1.7, preferably between 0.5 and 1.5, and more preferably between 0.7 and 1.3.

Surprisingly, it has been found that the intumescent properties of the inventive composition can be improved—that is, the intumescence factor can be increased—if the degree of crosslinking of the products of the reaction between the polyaspartic ester and the polyisocyanate is reduced or, as an additional component, at least one polyol which can react with the isocyanate compound to form a urethane group, is added to the composition according to the invention. This makes it possible to selectively adjust by an appropriate choice of the polyols, the intumescent properties of the composition. It was further surprising that the ash crust stability hardly changed by the addition of a polyol.

The polyol is preferably used with the polyamine, polyetheramine or polyaspartic ester in an OH:NH ratio of 0.05 eq.:0.95 eq. to 0.6 eq.:0.4 eq., more preferably in a ratio of 0.1 eq.:0.9 eq. to 0.5 eq:0.5 eq., and most preferably in a ratio of 0.2 eq.:0.8 eq. to 0.4 eq.:0.6 eq.

The polyol is preferably composed of a backbone of polyester, polyether, polyurethane and/or alkanes, or mixtures of these, having one or more hydroxyl-groups. The backbone can be linear or branched and the hydroxyl-functional groups terminal and/or along the chain.

More preferably, the polyester polyols are selected from condensation products of di- and polycarboxylic acids, for example aromatic acids such as phthalic acid and isophthalic acid, aliphatic acids such as adipic acid and maleic acid, cycloaliphatic acids such as hexahydrophthalic acid and tetrahydrophthalic acid, and/or derivatives thereof, such as anhydrides, esters or chlorides, and an excess amount of polyfunctional alcohols, for example aliphatic alcohols such as ethanediol, 1,2-propanediol, 1,6-hexanediol, neopentyl glycol, glycerol, trimethylolpropane and cycloaliphatic alcohols such as 1,4-cyclohexanedimethanol.

Furthermore, the polyester polyols are selected from polyacrylate polyols, such as copolymers of esters of acrylic and/or methacrylic acid, such as ethyl acrylate, butyl acrylate, methyl methacrylate with additional hydroxyl-groups, and styrene, vinyl esters and maleic acid esters. The hydroxyl-groups in these polymers are introduced via functionalized esters of acrylic and methacrylic acids, such as hydroxyethyl acrylate, hydroxyethyl methacrylate and/or hydroxypropyl methacrylate.

Furthermore, the polyester polyols are selected from polycarbonate polyols. Suitable polycarbonate polyols are hydroxyl-containing polycarbonates, for example polycarbonate diols. These can be obtained by the reaction of carbonic acid or carbonic acid derivatives with polyols or by the copolymerization of alkylene oxides such as propylene oxide with CO₂. Additionally or alternatively, the polycarbonates used are built of linear aliphatic chains. Suitable carbonic acid derivatives are carbonic diesters such as diphenyl carbonate, dimethyl carbonate or phosgene. Suitable polyols are for example diols such as ethylene glycol, 1,2- and 1,3-propanediol, 1,3- and 1,4-butanediol, 1,6-hexanediol, 1,8-octanediol, neopentyl glycol, 1,4-bis-hydroxymethyl cyclohexane, 2-methyl-1,3-propanediol, 2,2,4-trimethylpentanediol, 1,3-dipropylene glycol, polypropylene glycols, dibutylene glycol, polybutylene glycols, bisphenol A and lactone-modified diols of the type specified above.

Instead of or in addition to pure polycarbonate diols, polyether polycarbonate diols can be used.

Furthermore, the polyester polyols are selected from polycaprolactone polyols produced by ring-opening polymerization of ε-caprolactone with polyfunctional alcohols such as ethylene glycol, 1,2-propanediol, glycerin, and trimethylolpropane.

More preferably, the polyether polyols are also selected from among the addition products of, for example, ethylene oxide and/or propylene oxide and polyfunctional alcohols such as ethylene glycol, 1,2-propanediol, glycerol and/or trimethylolpropane.

Polyurethane polyols made from the poly-addition of diisocyanates with excess amounts of di- and/or polyols are more highly preferred.

More preferable are also di- or polyfunctional alcohols selected from among the C₂-C₁₀-alcohols with the hydroxyl groups at the ends and/or along the chain.

Most preferred are the above-mentioned polyester polyols, polyether polyols and C₂-C₁₀-alcohols which are di- and/or trifunctional.

Examples of suitable polyester polyols include DESMOPHEN® 1100, DESMOPHEN® 1652, DESMOPHEN® 1700, DESMOPHEN® 1800, DESMOPHEN® 670, DESMOPHEN® 800, DESMOPHEN® 850, DESMOPHEN® VP LS 2089, DESMOPHEN® VP LS 2249/1, DESMOPHEN® VP LS 2328, DESMOPHEN® VP LS 2388, DESMOPHEN® XP 2488 (Bayer), K-FLEX XM-360, K-FLEX 188, K-FLEX XM-359, K-FLEX A308 and K-FLEX XM 332 (King Industries). Examples of suitable commercially available polyether polyols include: ACCLAIM® POLYOL 12200 N, ACCLAIM® POLYOL 18200 N, ACCLAIM® POLYOL 4200, ACCLAIM® POLYOL 6300, ACCLAIM® POLYOL 8200 N, ARCOL® POLYOL 1070, ARCOL® POLYOL 1105 S, DESMOPHEN® 1110 BD, DESMOPHEN® 1111 BD, DESMOPHEN® 1262 BD, DESMOPHEN® 1380 BT, DESMOPHEN® 1381 BT, DESMOPHEN® 1400 BT, DESMOPHEN® 2060 BD, DESMOPHEN® 2061 BD, DESMOPHEN® 2062 BD, DESMOPHEN® 3061 BT, DESMOPHEN® 4011 T, DESMOPHEN® 4028 BD, DESMOPHEN® 4050 E, DESMOPHEN® 5031 BT, DESMOPHEN® 5034 BT and DESMOPHEN® 5031 BT (Bayer) or mixtures of polyester and polyether polyols such as WorléePol 230 (Worlée).

Examples of suitable alkanols include ethanediol, propanediol, propanetriol, butanediol, butanetriol, pentanediol, pentanetriol, hexanediol, hexanetriol, heptanediol; heptanetriol, octanediol, octanetriol, nonanediol, nonanetriol, decanediol and decanethiol.

In the event that the composition cures too slowly for the intended application, particularly when polyaspartic esters are used, a tertiary amine can also be added as a catalyst to the composition.

If the composition further contains polyols, in the case that the composition cures too slowly for the intended application, a catalyst can also be added to the composition, which is selected from among tin-containing compounds, bismuth-containing compounds, zirconium-containing compounds, aluminum-containing compounds or zinc-containing compounds. It is preferable that the above are tin octoate, tin oxalate, tin chloride, dioctyl tin di-(2-ethylhexanoate), dioctyltin dithioglycolate dilaurate, monobutyltin tris-(2-ethylhexanoate), dioctyltin dineodecanoate, dibutyltin dineodecanoate, dibutyltin diacetate, dibutyltin oxide, monobutyltin dihydroxychloride, organotin oxide, monobutyltin oxide, dioctyltin dicarboxlyate, dioctyltin stannoxane, bismuth carboxylate, bismuth oxide, bismuth neodecanoate, zinc neodecanoate, zinc octoate, zinc acetylacetonate, zinc oxalate, zinc acetate, zinc carboxylate, aluminum chelate complex, zirconium chelate complex, dimethylaminopropylamine, N,N-dimethylcyclohexylamine, N,N-dimethylethanolamine, N-(3-dimethylaminopropyl)N,N-diisopropanolamine, N-ethylmorpholine, N,N-methylmorpholine, pentamethyldiethylenetriamine and/or triethylenediamine.

Examples of suitable catalysts are Borchi® Kat 24, Borchi® Kat 320, Borchi® Kat 15 (Borchers), TIB KAT 129, TIB KAT P129, TIB KAT 160, TIB KAT 162, TIB KAT 214, TIB KAT 216, TIB KAT 218, TIB KAT 220, TIB KAT 232, TIB KAT 248, TIB KAT 248 LC, TIB KAT 250, TIB KAT 250, TIB KAT 256, TIB KAT 318, TIB Si 2000, TIB KAT 716, TIB KAT 718, TIB KAT 720, TIB KAT 616, TIB KAT 620, TIB KAT 634, TIB KAT 635, TIB KAT 815 (TIB Chemicals), K-KAT® XC-B221, K-KAT® 348, K-KAT® 4205, K-KAT® 5218, K-KAT® XK-635, K-KAT® XK-639, K-KAT® XK-604, K-KAT® XK-618 (King Industries), JEFFCAT® DMAPA, JEFFCAT® DMCHA, JEFFCAT® DMEA, JEFFCAT® DPA, JEFFCAT® NEM, JEFFCAT® NMM, JEFFCAT® PMDETA, JEFFCAT® TD-100 (Huntsman) and DABCO 33LV (Sigma Aldrich).

According to the invention, the C component contains an intumescent additive, wherein the additive can include both individual compounds as well as a mixture of several compounds.

Compounds which form an expanding, insulating layer of flame-resistant material when heated are advantageously used as intumescent additives. This layer protects the substrate from overheating and prevents or delays, at least as a result, the change in the mechanical and structural properties of load-bearing components by the action of heat. The formation of a voluminous, insulating layer, namely a layer of ash can be formed [sic] by the chemical reaction of a mixture of corresponding, mutually-adapted compounds which react with each other when exposed to heat. Such systems are known to the expert under the term chemical intumescence systems and can be used according to the invention. Alternatively, the voluminous, insulating layer can be formed by the expansion of a single compound which releases gases when exposed to heat, without a chemical reaction having taken place between the two compounds. Such systems are known to the expert under the term physical intumescence and can also be used according to the invention. Both systems can be used alone or in combination according to the invention.

For the formation of an intumescent layer by chemical intumescence, at least three components are generally required: a carbon source, a dehydrogenation catalyst and a blowing agent, contained for example in a binder in the case of coatings. Upon heating, the binder softens and the fire-protection additives are released such that they can react, in the case of chemical intumescence, with each other, or in the case of physical intumescence, can expand. The acid is formed from the dehydrogenation catalyst by thermal decomposition, and serves as a catalyst for the carbonization of the carbon source. At the same time, the blowing agent thermally decomposes to form inert gases which cause a swelling of the carbonized (blackened) material and optionally of the softened binder, to form a voluminous insulating foam.

In one embodiment of the invention, in which the insulating layer is formed by chemical intumescence, the intumescent additive comprises at least one carbon skeleton forming compound—if the binder cannot be used as such—at least one acidifier, at least one blowing agent, and at least one inorganic skeleton forming compound. The components of the additive are particularly selected such that they can develop a synergy, wherein some of the compounds can have multiple functions.

As the carbon source, the compounds commonly used in intumescent fire protection formulations and known to those skilled in the art can be considered, such as starch-like compounds, for example starch and modified starch, and/or polyhydric alcohols (polyols) such as saccharides, oligosaccharides and polysaccharides, and/or a thermoplastic or thermosetting polymeric resin binder such as a phenolic resin, a urea resin, a polyurethane, polyvinyl chloride, poly(meth)acrylate, polyvinyl acetate, polyvinyl alcohol, a silicone resin and/or a rubber. Suitable polyols are polyols selected from the group containing sugar, pentaerythritol, dipentaerythritol, tripentaerythritol, polyvinyl acetate, polyvinyl alcohol, sorbitol, and polyoxyethylene/polyoxypropylene-(EO-PO—)-polyols. Pentaerythritol, dipentaerythritol, or polyvinyl acetate are preferably used.

It should be noted that in a fire, the binder itself can also have the function of a carbon source.

As the dehydrogenation catalysts or acid generators, compounds which are commonly used in intumescent fire protection formulations and known to those skilled in the art can be contemplated, such as a salt or ester of an inorganic, non-volatile acid selected from among sulfuric acid, phosphoric acid or boric acid. In particular, phosphorus-containing compounds are used which have very large palettes because they extend over multiple oxidation states of the phosphorus, such as phosphines, phosphine oxides, phosphonium compounds, phosphates, elemental red phosphorus, phosphites and phosphates. Such phosphoric acid compounds can be, by way of example: monoammonium phosphate, diammonium phosphate, ammonium phosphate, ammonium polyphosphate, melamine phosphate, melamine resin phosphate, potassium phosphate, polyolphosphates such as pentaerythritol phosphate, glycerol phosphate, sorbitol phosphate, mannitol phosphate, dulcitol phosphate, neopentylglycol phosphate, ethylene glycol phosphate, dipentaerythritol phosphate, and the like. A polyphosphate or ammonium polyphosphate is preferably used as the phosphoric acid compound. Melamine resin phosphates in this case can be compounds such as reaction products of Lamelite C (melamine formaldehyde resin) and phosphoric acid. Sulfuric acid compounds can be, for example: ammonium sulfate, ammonium sulfamate, nitroaniline bisulfate, 4-nitroaniline-2-sulfonic acid and 4,4-dinitrosulfanilamide, and the like. The boric acids compound can be melamine borate, by way of example.

The compounds commonly used in fire protection formulations and known to those skilled in the art can be contemplated as suitable blowing agents, such as cyanuric acid or isocyanic acid and derivatives thereof, melamine, and derivatives thereof. These are: cyanamide, dicyanamide, dicyandiamide, guanidine and its salts, biguanide, melamine cyanurate, salts of cyanic acid, cyanate esters and amides, hexamethoxymethylmelamine, dimelamine pyrophosphate, melamine polyphosphate, and melamine phosphate. Preferably, hexamethoxymethylmelamine or melamine (cyanuric amide) are used.

Furthermore, components with functionalities not limited to a single function, such as melamine polyphosphate, which acts both as an acid generator as well as a blowing agent, are also suitable. Further examples are described in GB 2 007 689 A1, EP 139 401 A1 and U.S. Pat. No. 3,969,291 A1.

In one embodiment of the invention, in which the insulating layer is formed by, in addition to chemical intumescence, physical intumescence as well, the intumescent additive further comprises at least one thermally expandable compound such as a graphite intercalation compound, which is also known as exfoliated graphite. These can also be incorporated into the binder.

As expandable graphite, by way of example, known intercalation compounds of SOₓ, NOₓ, halogen and/or acids into graphite can be contemplated. These are also referred to as graphite salts. Expandable graphites which swell and release SO₂, SO₃, NO and/or NO₂ at temperatures of, for example, 120 to 350° C. are preferred. The expandable graphite can be in the form of flakes having a maximum diameter in the range of 0.1 to 5 mm, by way of example. Preferably, this diameter lies in the range from 0.5 to 3 mm. For the present invention, suitable expandable graphites can be obtained on the commercial market. In general, the particles of exfoliated graphite are uniformly distributed in the composition according to the invention. The concentration of particles of exfoliated graphite can also be varied at points, in a pattern, over a surface and/or in the form of a sandwich. In this regard, reference is hereby made to EP 1489136 A1, the content of which is hereby incorporated into this application.

Since the ash crust formed in case of fire in some cases is too unstable and can therefore, depending on its density and structure, be blown away by air currents, which adversely affects the insulating effect of the coating, at least one ash crust stabilizer can be added to the components just mentioned.

Skeleton forming compounds, such as those commonly used in fire protection formulations and known to those skilled in the art can be contemplated as ash crust stabilizers, such as expanded graphite and particulate metals such as aluminum, magnesium, iron and zinc. The particulate metal can be in the form of a powder, flakes, scales, fibers, threads and/or whiskers, wherein the particulate metal in the form of powder, flakes or scales preferably has a particle size of ≦50 μm, preferably from 0.5 to 10 μm. In cases where the particulate metal is in the form of fibers, threads and/or whiskers, a thickness of 0.5 to 10 μm and a length of 10 to 50 μm is preferred. Alternatively or additionally, an oxide or compound of a metal of the group comprising aluminum, magnesium, iron or zinc can be used as the ash crust stabilizer, in particular iron oxide, preferably ferric oxide, titanium dioxide, a borate such as zinc borate and/or a glass frit composed of low-melting temperature glasses with a melting point of preferably at or above 400° C., phosphate or sulfate glasses, melamine polyzinc sulfates, ferroglasses, or calcium borosilicates. The addition of such an ash crust stabilizer contributes to a significant stabilization of the ash crust in case of fire, as these additives increase the mechanical strength of the intumescent layer and/or prevent dripping. Examples of such additives can also be found in U.S. Pat. No. 4,442,157 A, U.S. Pat. No. 3,562,197 A, GB 755 551 A and EP 138 546 A1.

In addition, ash crust stabilizers such as melamine phosphate or melamine borate can be included.

Optionally, one or more reactive flame retardants can be added to the composition according to the invention. Such compounds are incorporated in the binder. An example according to the invention is reactive organophosphorus compounds such as 9,10-dihydro-9-oxa-10-phosphaphenanthrene-10-oxide (DOPO) and its derivatives, such as DOPO-HQ, DOPO-NQ, and adducts. Such compounds are described, for example in S. V. Levchik, E. D. Weil, Polym. Int 2004, 53, 1901-1929 or E. D. Weil, S. V. Levchik (ed.), Flame Retardants for Plastic and Textiles—Practical Applications, Hanser, 2009.

The intumescent additive can be used in the composition in an amount of 30 to 99% by weight, wherein the amount is substantially dependent on the application form of the composition (spraying, brushing and the like). In order to effect the highest possible intumescence rate, the proportion of the C component is set as high as possible in the total formulation. Preferably, the proportion of C component in the total formulation is 35 to 85% by weight and particularly preferably 40 to 85% by weight.

The composition can optionally contain, in addition to the intumescent additives, conventional auxiliaries such as solvents, for example xylene or toluene, wetting agents, for example based on polyacrylates and/or polyphosphates, defoamers such as silicone defoamers, thickeners such as alginate, dyes, fungicides, plasticizers such as chlorinated waxes, binders, flame retardants, and various fillers such as vermiculite, inorganic fibers, silica sand, glass micro beads, mica, silica, mineral wool, and the like.

Additional additives, such as thickeners, rheology additives and fillers can be added to the composition. Preferably used as rheological additives, such as anti-settling, anti-sag and thixotropic agents, are polyhydroxycarbonic acid amides, urea derivatives, salts of unsaturated carboxylic esters, alkylammonium salts of acidic phosphoric acid derivatives, ketoximes, amine salts of p-toluene sulfonic acid, amine salts of sulphonic acid derivatives and aqueous or organic solutions or mixtures of these compounds. In addition, rheology additives can be used which are based on pyrogenic or precipitated silicas or based on silanized pyrogenic or precipitated silicas. The rheology additives are preferably pyrogenic silicas, modified and unmodified sheet silicates, precipitated silicas, cellulose ethers, polysaccharides, polyurethane and acrylic thickeners, urea derivatives, castor oil derivatives, polyamides and fatty acid amides and polyolefins, as long as they are in solid form, powdered celluloses and/or suspending agents such as xanthan gum.

The composition according to the invention can be formulated as a two- or multi-component system.

Because a reaction occurs at room temperature, the A component and the B component must be arranged separately to inhibit reaction. In the presence of a catalyst, the same can be either stored separately from the components A and B, or can be included in one of these components or distributed across both ingredients. This ensures that the two components A and B of the binder are mixed just before application and trigger the curing reaction. This makes the system easier to manipulate.

In one preferred embodiment of the invention, the inventive composition is formulated as a two-component system, wherein the A component and the B component are arranged separately to inhibit reaction. Accordingly, a first component, the I component, contains the A component, and a second component, the II component, contains the B component. This achieves a configuration wherein the two constituents A and B of the binder are only mixed with one another immediately before use and trigger the curing reaction. This makes the system easier to use.

The C component in this case can be divided, as a complete mixture or as individual components, into a first component I and/or a second component II. The C component is distributed according to the compatibility of the compounds contained in the composition, such that neither can a reaction and/or mutual interference of the compounds contained in the composition occur, nor can there be a reaction of these compounds with the compounds of the other components. This is dependent on the compounds used. This ensures that the highest possible fraction of fillers can be attained. This leads to a high intumescence, even at low coating thicknesses of the composition.

The composition is applied as a paste with a brush, a roller or by spraying onto the substrate, in particular a metallic substrate. Preferably, the composition is applied by means of an airless spray method.

The composition according to the invention is characterized by, compared to the solvent and water-based systems, a relatively fast curing as the result of an addition reaction, and therefore the lack of necessity for drying time. This is particularly important when the coated components must be loaded and/or worked on quickly, either by coating with a topcoat or being moved or transported. The coating is therefore also significantly less susceptible to external influences on the construction site, such as the action of (rain) water, dust and dirt, which can lead, in solvent or water-based systems, to leaching of water-soluble ingredients such as ammonium polyphosphate, and/or, in the case of dust being absorbed, to reduced intumescence. Due to the low viscosity of the composition, despite the high solids content, the composition remains easy to work with, particularly using established spraying methods. Due to the low softening point of the binder and high solids content, the rate of expansion when exposed to heat is high even at low layer thickness.

In addition, a dried layer of the composition according to the invention has a very high water resistance even against salt water, compared with conventional water-based or solvent-based systems.

Therefore, the composition according to the invention is suitable as a coating, in particular as a flame-retardant coating, and preferably a sprayable coating for metallic and non-metallic substrates. The substrates are not restricted and include components, particularly steel components and wooden components, as well as individual cables, cable bundles, cable trays and cable ducts or other conduits.

The composition according to the invention can be used, primarily in the construction industry, as a coating, in particular a fire protection coating for steel construction elements, but also for construction elements made from other materials, such as concrete or wood, as well as a fire protection coating for single cable, cable bundles, cable trays and cable ducts or other conduits.

Another object of the invention is therefore the use of the composition according to the invention as a coating, particularly as a coating for structural elements or components of steel, concrete, wood and other materials, such as plastics, particularly as a fire protection coating.

The present invention also relates to objects that are obtained when the inventive composition is cured. The objects have excellent intumescent properties.

The following examples serve to further illustrate the invention.

### EMBODIMENTS

For the production of intumescent compositions according to the invention, the individual components as specified below are mixed with the aid of a dissolver and homogenized.

The curing behavior was observed in each case, then the intumescence factor and relative ash crust stability determined. For this purpose the compositions were each placed in a circular Teflon mold of approximately 2 mm depth and 48 mm diameter.

The time for the curing corresponds in this case to the time after which the samples were hardened and the Teflon mold could be removed.

To determine the intumescence factor and the relative ash crust stability, a muffle furnace was preheated to 600° C. The sample thickness was measured redundantly using a caliper, then the average value h_{M} was calculated. Next, the samples were each placed in a cylindrical steel mold and heated for 30 min in a muffle furnace. After cooling to room temperature, the foam height h_{E1} was initially determined non-destructively (average value of multiple measurements). The intumescence factor I was calculated as follows:

intumescence factor I: I=h_{E1}:h_{M}

Next, a defined weight (m=105 g) was dropped from a defined height (h=100 mm) onto the foam in the cylindrical steel mold, and the foam height h_{E2} was determined following this partially destructive action. The relative ash crust stability was calculated as follows:

relative ash crust stability (ACS): ACS=h_{E2}:h_{E1}

In the following examples, the following composition was used as the C component:

C Component:

| Component | Amount [g] |
|---|---|
| pentaerythritol | 8.7 |
| melamine | 8.7 |
| ammonium polyphosphate | 16.6 |
| titanium dioxide | 7.9 |

### Comparative Example 1

### A Component

| Compounds | Amount [g] |
|---|---|
| Desmophen 1150 | 100.0 |

### B Component

| Compounds | Amount [g] |
|---|---|
| Desmodur VL | 45.0 |

### C Component

| Compounds | Amount [g] |
|---|---|
| as specified above | 163.0 |

### Comparative Example 2

A commercial fire protection product (Hilti CFP S-WB) based on aqueous dispersion technology was used as a comparison.

### Comparative Example 3

As a further comparison, a standard epoxy-amine system (Jeffamin® T-403, liquid, solvent-free, crystallization stable epoxy resin, [sic] consisting of low molecular weight epoxy resins based on bisphenol A and bisphenol F (Epilox® AF 18-30, Leuna-Harze GmbH) and 1,6-hexanediol diglycidyl ether), which is 60% filled with an intumescence mixture as in the above examples, was tested.

### Comparative Example 4

As a further comparison, a standard epoxy-amine system (isophoronediamine, trimethylolpropane triiacrylate, and liquid, solvent-free and crystallization-stable epoxy resin consisting of low molecular weight epoxy resins based on bisphenol A and bisphenol F (Epilox® AF 18-30, Leuna-Harze GmbH)), which is 60% filled with an intumescence mixture as in the above examples, was tested.

### Example 1

### A Component

| Compounds | Amount [g] |
|---|---|
| aspartic ester¹ | 12.9 |
| DESMOPHEN ® 1150 | 5.4 |

### B Component

| Compounds | Amount [g] |
|---|---|
| DESMODUR ® N 3600 | 11.9 |

### C Component

| Compounds | Amount [g] |
|---|---|
| as specified above | 45.0 |

### Example 2

### A Component

| Compounds | Amount [g] |
|---|---|
| DESMOPHEN ® NH 1520 | 8.3 |
| DESMOPHEN ® 1150 | 10.3 |

### B Component

| Compounds | Amount [g] |
|---|---|
| DESMODUR ® N 3600 | 11.5 |

### C Component

| Compounds | Amount [g] |
|---|---|
| as specified above | 45.0 |

### Example 3

### A Component

| Compounds | Amount [g] |
|---|---|
| DESMOPHEN ® NH 1420 | 20.51 |

### B Component

| Compounds | Amount [g] |
|---|---|
| DESMODUR ® N 3600 | 9.6 |

### C Component

| Compounds | Amount [g] |
|---|---|
| as specified above | 45.0 |

### Example 4

### A Component

| Compounds | Amount [g] |
|---|---|
| DESMOPHEN ® NH 1520 | 20.8 |

### B Component

| Compounds | Amount [g] |
|---|---|
| DESMODUR ® N 3600 | 9.2 |

### C Component

| Compounds | Amount [g] |
|---|---|
| as specified above | 45.0 |

From the results shown in Table 1 it is clear that the curing of the compositions according to the invention is faster than the comparative composition.

TABLE 1
Results of curing time measurements

| | Sample | | |
|---|---|---|---|
| | thickness | Curing | |
| Example | h_{M} (mm) | time | |
| 1 | 5 | 15 | hours |
| 2 | 5 | 1 | day |
| 3 | 5 | 3 | hours |
| 4 | 5 | 15 | hours |
| Comparative | 2 | 10 | days |
| example | | | |
| 2 | | | |

TABLE 2
Results of intumescence factor measurements
and ash crust stability measurements

| | | Relative | Sample |
|---|---|---|---|
| | Intumescence | ash crust stability | thickness |
| | factor I | ACS | h_{M} |
| Example | (multiple) | (multiple) | (mm) |
| 1 | 14 | 0.88 | 1.15 |
| 2 | 11 | 0.71 | 1.27 |
| 3 | 5 | 0.83 | 5.6 |
| 4 | 9 | 0.67 | 1.4 |
| Comparative | sample destroyed, so intumescence | | 1.4 |
| example 1 | | | |
| Comparative | 22 | 0.04 | 1.6 |
| example 2 | | | |
| Comparative | 1.7 | 0.60 | 1.2 |
| example 3 | | | |

1. An intumescent composition, comprising
an isocyanate component,
a reactive component having at least two primary and/or secondary amino groups, and
an intumescent additive component.

2. The intumescent composition of claim 1 wherein said intumescent additive comprises at least one carbon source, at least one dehydrogenation catalyst, and at least one blowing agent.

3. An intumescent composition of claim 1 wherein the reactive component is selected from polyamines, polyether polyamines, and polyaspartic esters, or a mixture thereof.

4. An intumescent composition of claim 3 wherein the reactive component is a polyether polyamine having the general formula (I) 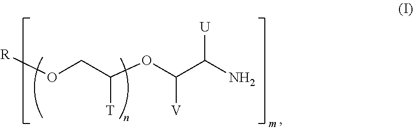
in which
R is the moiety of an initiator for oxyalkylation, having 2 to 12 carbon atoms and 2 to 8 groups containing active hydrogen atoms,
T is hydrogen or a C₁C₄-alkyl group,
V and U are hydrogen or T, irrespective of each other,
n is a value between 0 and 100 is,
m is a whole number between 2 and 8, wherein m corresponds to the number of groups with an active hydrogen atom which were originally contained in the initiator for the oxyalkylation.

5. An intumescent composition of claim 3 wherein the reactive component is a polyaspartic ester having the general formula (VII), 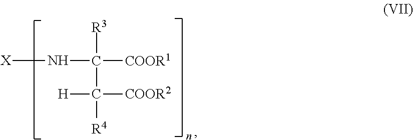
in which
R¹ and R² can be the same or different, and represent organic moieties which are inert towards isocyanate groups,
R³ and R⁴ can be the same or different and represent hydrogen or organic moieties which are inert to isocyanate groups,
X is an n-valent organic moiety which is inert towards isocyanate groups, and
n is a whole number of at least 2.

6. An intumescent composition of claim 5 wherein in formula (VII), R¹ and R² are a methyl- or ethyl-group and R³ and R⁴ each represent hydrogen.

7. An intumescent composition of claim 5 wherein in Formula (VII), X represents a moiety as can be obtained by the removal of the primary amino group from an aliphatic polyamine.

8. An intumescent composition of claim 7 wherein X represents a moiety as can be obtained by the removal of the primary amino-groups from 1,4-diaminobutane, 1,6-diaminohexane, 2,2,4- or 2,4,4-trimethyl-1,6-diaminohexane, 1-amino-3,3,5-trimethyl-5-aminomethylcyclohexane, 4,4′-diaminodicyclohexylmethane, or 3,3′-dimethyl-4,4′-diamino-dicyclohexylmethane, diethylene triamine and triethylene tetramine, wherein n represents the number 2.

9. An intumescent composition of claim 1 wherein the reactive component furthermore contains a polyol compound.

10. An intumescent composition of claim 9 wherein the polyol compound is selected from polyester polyols, polyether polyols, hydroxylated polyurethanes and/or alkanes, each having two hydroxyl-groups per molecule.

11. An intumescent composition of claim 10 wherein the polyol compound is selected from compounds which have a backbone of polyester, polyether, polyurethane, and/or alkanes or mixtures of these and one or more hydroxyl-groups.

12. An intumescent composition of claim 1 wherein the isocyanate compound has an aliphatic or aromatic backbone and at least two isocyanate groups or a mixture thereof.

13. An intumescent composition of claim 1 wherein the proportion of the isocyanate component and reactive component is selected such that the ratio of equivalents of isocyanate groups of the isocyanate compound to the groups of the reactive component which is capable of reaction with isocyanate compounds is between 0.3 and 1.7.

14. An intumescent composition of claim 1 which further contains a catalyst for the reaction between the isocyanate compound and the reactive component.

15. An intumescent composition of claim 1 wherein the intumescent additive further includes at least one compound capable of thermal expansion.

16. An intumescent composition of claim 15 wherein the intumescent additive furthermore contains an ash crust stabilizer.

17. An intumescent composition of claim 1 wherein the composition furthermore contains organic and/or inorganic additives, and/or additional additives.

18. An intumescent composition of claim 1 which is produced as a two- or multi-component system.

19. An intumescent composition of claim 18 wherein the composition is produced as a two-component system, and the isocyanate component and the reactive component are separated into two components.

20. An intumescent composition of claim 19 wherein the intumescent additive component is divided the two components in such a manner that these compounds are separated from each other.

21. An intumescent composition of claim 20 wherein the intumescent additive component further contains an ash crust stabilizer which is divided among the two components.

22. A cured object comprising a cured composition of claim 1.

23. The use of an intumescent composition as a coating comprising:
providing an intumescent composition comprising an isocyanate component, a reactive component having at least two primary and/or secondary amino groups, and an intumescent additive component; and
coating said intumescent composition on a substrate.
